(19) United States
(12) Patent Application Publication
(10) Pub. No.: US 2004/0094880 A1
(43) Pub. Date: May 20, 2004

(54) Polyurethane foam shock absorber

(76) Inventor: Bai-Hsin Lee, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/298,365

(22) Filed: Nov. 18, 2002

(51) Int. Cl. F16F 7/00

(52) U.S. Cl. 267/141; 267/276; 267/257

(57) ABSTRACT

A PU foam shock absorber in accordance with the present invention is composed of a tube (10), a resilient core (11) mounted inside the tube (10) and a cap. The resilient core (11) is made of PU foam to absorb and to buffer shock. Additionally, the resilient core (11) may be selectively divided into multiple sections of different density and hardness to adjust the damping coefficient of the shock absorber.

### BACKGROUND OF THE INVENTION

1. Field of the Invention

The present invention relates to a shock absorber, and more particularly to a shock absorber that uses polyurethane foam as a resilient core and has an excellent shock-absorbing capability.

2. Description of Related Art

Shock-absorbing devices are widely used on most modern bicycles, motorcycles and exercise machines to attenuate shock and vibration caused during operation. Because the shock-absorbing devices attenuate shock, the machines do not receive the full force of the impact, which reduces the likelihood of damage to instruments mounted on or in the machine. Additionally, users are not injured or feel uncomfortable when using the machine.

Two conventional shock-absorbing devices are presently used.

1. Spring: A spring is flexible and resilient so it automatically flexes when a shock is applied to the spring. Since springs are cheap, they are most often chosen as a low-cost shock absorber. However, springs are made of resilient material and store and transmit energy to the machines or users when a shock is applied to the spring.

2. Oleo shock absorber: oleo or oil filled shock absorbers have significantly better shock-absorbing features than the springs. However, oleo shock absorbers are expensive and cannot be changed easily when the oleo shock absorber is broken or worn out.

Therefore, the present invention has arisen to mitigate or obviate the drawbacks of conventional damping devices.

### SUMMARY OF THE INVENTION

The main objective of the present invention is to provide a low cost shock absorber with excellent shock-absorbing features.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a PU foam shock absorber in accordance with the present invention;

FIG. 2 is a side plan view in partial section of the PU foam shock absorber in FIG. 1;

FIG. 3 is an exploded perspective view of a second embodiment of the PU foam shock absorber in accordance with the present invention;

FIG. 4 is a side plan view in partial section of the second embodiment of the PU foam shock absorber in FIG. 3;

FIG. 5 is an operational side plan view in partial section of the PU foam shock absorber in FIG. 4;

FIG. 6 is an exploded perspective view of a third embodiment of the PU foam shock absorber in accordance with the present invention; and

FIG. 7 is an exploded perspective view of a fourth embodiment of the PU foam shock absorber in accordance with the present invention.

### DETAILED DESCRIPTION OF THE INVENTION

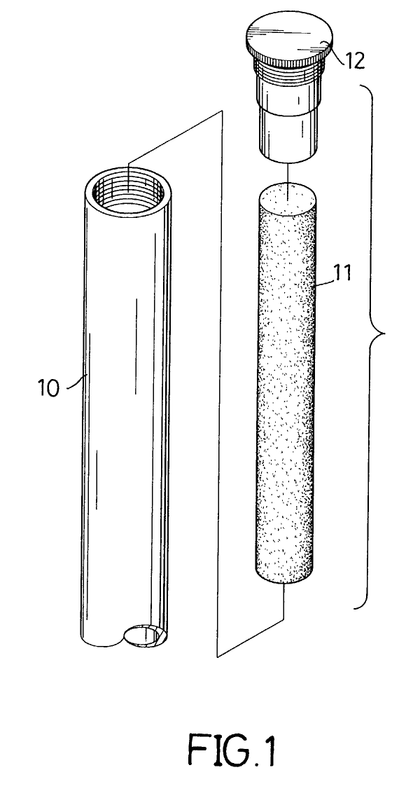

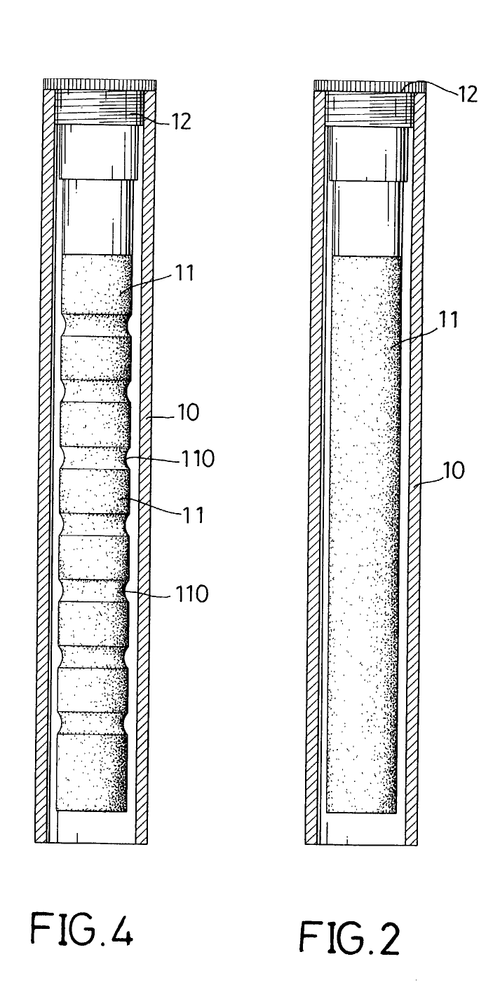

With reference to FIGS. 1 and 2, a PU foam shock absorber in accordance with the present invention comprises a tube (10), a resilient core (11) and a cap (12).

The tube (10) has an open end, an inner surface and an interior thread. The inner surface holds the resilient core (11) inside, and the interior thread is defined in the inner surface near the open end.

The resilient core (11) with an outer periphery is made of polyurethane foam and is rod-shaped to correspond to the tube (10). The polyurethane foam has a density range of 0.4-0.9 g/cm³ and a hardness range of 50°-95° (according to shore C testing unit). Additionally, the preferred density range of the PU foam is 0.55-0.8 g/cm³. The resilient core (11) is selectively composed of at least one section.

The cap (12) is mounted on the open end of the tube (10) by a thread corresponding to the interior thread in the tube (10).

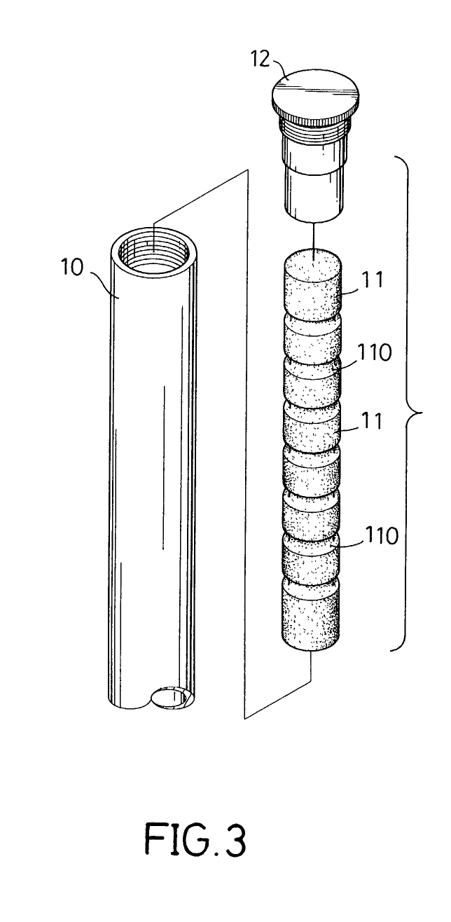

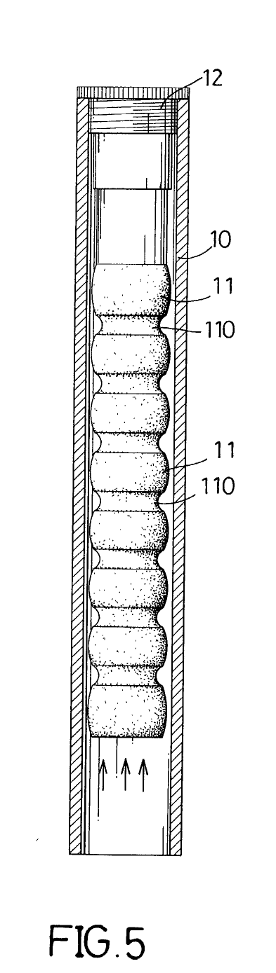

With reference to FIGS. 3, 4 and 5, the resilient core (11) of a second embodiment of the PU foam shock absorber has multiple annular arced grooves (110) defined on the outer periphery of the resilient core (11). The arced grooves (110) provide more space for the resilient core (11) to compress and have excellent shock absorbing features. When the shock absorber receives shocks, the resilient core (11) contacts with the cap (12) at one end and is compressed with most of the shortening occurring in the area of the arced grooves (110) by shock powder as shown by arrows in FIG. 5. Therefore, the resilient core (11) absorbs the shock power efficiently.

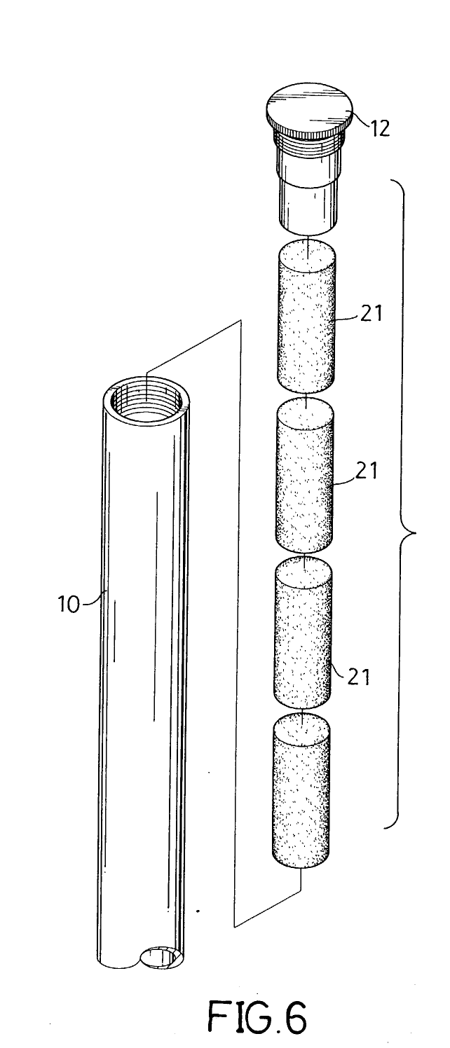

With reference to FIG. 6, the resilient core in a third embodiment of the PU foam shock absorber in accordance with the present invention is composed of multiple sections (21). The PU foam in each section (21) may have a different density and hardness from the other sections to achieve a desired damping coefficient for the shock absorber.

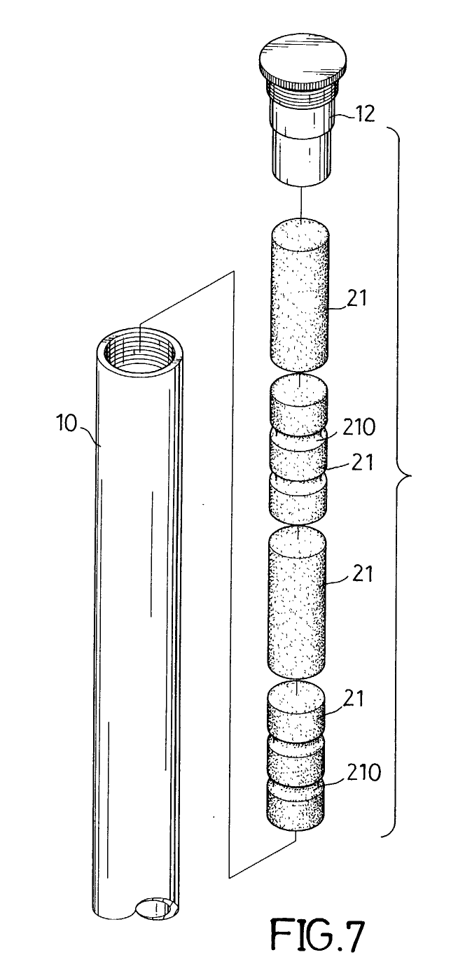

With reference to FIG. 7, the sections (21) of the resilient core selectively have annular arced grooves (210) defined in certain sections (21) to improve the shock-absorbing feature.

To understand the advantages of the PU foam shock absorber in accordance the present invention, table 1 shows a comparison between the PU foam shock absorber and the conventional damping devices.

TABLE 1

| | Oleo- | | PU foam | |
|---|---|---|---|---|
| | shock | Spring | shock | |
| Characteristics | absorber | damper | absorber | Note |
| Weight | Heavy | Minor | Light | Take shock absorber of 4 mm diameter for |
| | | | | example. The oleo-shock absorber is 1.6 |
| | | | | times heavier than the spring damper and |
| | | | | is 6 times heavier the PU foam shock |
| | | | | absorber. |
| Damping | Good | Bad | Excellent | The PU foam resilient core buffers and |
| efficiency | | | | absorbs the shock power but the others do |
| | | | | not. |
| Resiliency | Good | Bad | Excellent | After compression deformation test, the |
| | | | | spring damper deforms 10%; the PU foam |
| | | | | shock absorber deforms 1%; and the oleo- |
| | | | | shock absorber deforms 0.5% (in shape of |
| | | | | tube). |
| Variety | Bad | Bad | Good | Varying the density and hardness of the |
| | | | | PU resilient core allows the damping |
| | | | | coefficient to be modified to meet |
| | | | | different requirements. |
| Fix | Not easy | Easy | Easy | The oleo-shock absorber often has sealing |
| | | | | problems and is hard to repair. |
| Noise | less | Lot | Less | The spring is rigid and rubs against the |
| | | | | tube to make more noise than the others. |
| Price | Expensive | Cheap | Minor | The oleo-shock absorber is more |
| | | | | expensive than the others. |

Although the invention has been explained in relation to its preferred embodiment, it is to be understood that many other possible modifications and variations can be made without departing from the spirit and scope of the invention as hereinafter claimed.

What is claimed is:

1. A polyurethane (PU) foam shock absorber in accordance with the present invention comprising:
a tube (10) having an open end;
a resilient core (11) made of polyurethane (PU) foam and mounted inside the tube (10); and
a cap (12) mounted on the open end of the tube (10) to enclose the resilient core (11) inside the tube (10);
wherein the resilient core (11) is rod-shaped and has a density of 0.4-0.9 g/cm³ and a hardness of 50°-95° (shore C).

2. The PU foam shock absorber as claimed in claim 1, wherein the resilient core (11) has a preferred density of 0.55-0.8 g/cm³.

3. The PU foam shock absorber as claimed in claim 1, wherein the resilient core (11) has multiple annular arced grooves (110) defined on an outer periphery of the resilient core (11).

4. The PU foam shock absorber as claimed in claim 1, wherein the resilient core is composed of multiple sections (21) of PU foam and each section has a hardness and density different from the others.

5. The PU foam shock absorber as claimed in claim 4, wherein the sections (21) of resilient core selectively have annular arced grooves (210) defined around the outer periphery of the resilient core.
